(19) United States
(12) Patent Application Publication
(10) Pub. No.: US 2020/0062246 A1
(43) Pub. Date: Feb. 27, 2020

(54) EMERGENCY BRAKING DEVICE FOR VEHICLE

(71) Applicant: MANDO Corporation, Gyeonggi-do (KR)

(72) Inventor: JiYeol PARK, Seoul (KR)

(21) Appl. No.: 16/550,610

(22) Filed: Aug. 26, 2019

(30) Foreign Application Priority Data
Aug. 27, 2018 (KR) 10-2018-0100470
Jun. 28, 2019 (KR) 10-2019-0077817

(51) Int. Cl. B60W 30/09; B60W 30/095; B60W 10/18; B60K 28/06; B60W 40/09

(52) U.S. Cl. CPC B60W 30/09; B60W 30/0953; B60W 2040/0818; B60K 28/06; B60W 40/09; B60W 10/18

(57) ABSTRACT

Disclosed is an emergency braking apparatus for a vehicle. The emergency braking apparatus includes a sensor mounted to a host vehicle and configured to detect the outer or inner area of the host vehicle, a processor configured to process data collected by the sensor, and a controller configured to provide control signals for controlling the host vehicle based on the data processed by the processor. The sensor detects a state of a driver or a traveling state of the host vehicle. The processor determines whether the driver is inattentive based on the detected state of the driver or the detected traveling state of the host vehicle. The controller provides a braking signal for braking the host vehicle if it is determined that the driver is inattentive.

This application is based on and claims priority under 35 U.S.C. 119 to Korean Patent Application No. 10-2018-0100470, filed on Aug. 27, 2018, and No. 10-2019-0077817, filed on Jun. 28, 2019, in the Korean Intellectual Property Office, the disclosures of which is herein incorporated by reference in their entireties.

### BACKGROUND OF THE INVENTION

### 1. Technical Field

The present invention relates to an emergency braking apparatus for a vehicle.

### 2. Description of the Related Art

In general, in order to assist the safe driving of a driver, various driving assistant systems are mounted on vehicles. The driving assistant system is a safety device for detecting a collision risk using an advanced sensor and warning a driver against a danger of an accident and decelerating the speed or performing emergency braking for front or side collision avoidance.

However, the conventional driving assistant system has a problem in that it does not incorporate all of various driving conditions of a driver. The reason for this is that a lack of sleep, a monotonous road state, the use of an interior article or a health-related state makes a driver a careless state, such as that drowsiness is caused or attention is reduced.

Furthermore, there is a good possibility that response speed is reduced in such a careless state and drowsiness may pose a danger to a fellow passenger and the passenger or pedestrian of a different vehicle in addition to a driver.

Accordingly, there is a need for overall improvement for such a part.

### PRIOR ART DOCUMENT

### Patent Document

(Patent Document 1) Korean Patent No. 10-1511858 (Apr. 7, 2015)

### SUMMARY OF THE INVENTION

An embodiment of the present invention is to provide an emergency braking apparatus for performing the braking of a host vehicle by incorporating an inattentive condition of a driver.

In particular, an embodiment of the present invention is to provide an emergency braking apparatus for accurately determining an inattentive state of a driver using various sensors and performing the braking of a host vehicle based on the inattentive condition of the driver.

Furthermore, an embodiment of the present invention is to provide an emergency braking apparatus for performing the braking of a host vehicle depending on whether a preceding vehicle is present and whether a driver involves braking in a driver inattention state.

Furthermore, an embodiment of the present invention is to provide an emergency braking apparatus capable of preventing a rear collision of a following vehicle upon emergency braking.

Furthermore, an embodiment of the present invention is to provide an emergency braking apparatus for a vehicle, which performs vehicle braking by taking into consideration that a driver performs an erroneous driving manipulation in an inattentive state.

In an aspect, an emergency braking apparatus for a host vehicle includes a sensor mounted to the host vehicle and configured to detect the outer or inner area of the host vehicle, a processor configured to process data collected by the sensor, and a controller configured to provide control signals for controlling the host vehicle based on the data processed by the processor. The sensor detects a state of a driver or a traveling state of the host vehicle. The processor determines a level of inattentiveness of the driver based on the detected state of the driver or the detected traveling state of the host vehicle. The controller provides a braking signal for braking the host vehicle based on the level of inattentiveness of the driver.

In this case, the sensor may detect a motion of the driver or the traveling state of the host vehicle.

Furthermore, the sensor may detect whether a preceding vehicle is present. The processor may determine an expected collision time based on a relative velocity and relative distance between the host vehicle and the preceding vehicle if the preceding vehicle is present, and may determine whether a collision occurs by comparing the expected collision time with a collision risk time. The controller may provide the braking signal for braking the host vehicle if the expected collision time is smaller than the collision risk time.

In this case, the processor may determine a target deceleration quantity to be reached by the host vehicle and a target pedal force value necessary to reach the target deceleration quantity in order for the relative velocity between the host vehicle and the preceding vehicle is a given velocity or less. If the target deceleration quantity is smaller than a deceleration threshold value reachable through emergency braking, the processor may determine a situation in which normal braking is possible.

Alternatively, in the situation in which normal braking is possible, the controller may provide the braking signal for braking the host vehicle based on a pedal force value of the brake pedal of the host vehicle.

If the pedal force value is smaller than a minimum pedal force value capable of braking the host vehicle, the processor may determine to change into a situation in which an emergency action is necessary.

Alternatively, if the pedal force value is not smaller than the minimum pedal force value capable of braking the host vehicle, the processor may compare the pedal force value with the target pedal force value, and the controller may provide the braking signal for braking the host vehicle.

In this case, if the pedal force value is smaller than the target pedal force value, the controller may assist the pedal force of the brake pedal so that the pedal force value reaches the target pedal force value.

Alternatively, if the pedal force value is not smaller the target pedal force value, the controller may provide the braking signal for braking the host vehicle based on the pedal force value.

Furthermore, the processor may determine a target deceleration quantity for the host vehicle so that the relative velocity between the host vehicle and the preceding vehicle is a given velocity or less. If the target deceleration quantity is greater than a deceleration threshold value reachable through emergency braking, the processor may determine a situation in which an emergency action is necessary.

In this case, in the situation in which an emergency action is necessary, the controller may provide an emergency action signal for preventing a front collision against the preceding vehicle and a rear collision against a following vehicle.

Furthermore, the processor may determine a level of inattentiveness of the driver based on data collected by the sensor. If an emergency action is necessary based on the level of inattentiveness of the driver, the controller may provide a signal to warn an emergency braking situation, a driver protection action signal, and an emergency braking signal simultaneously.

At this time, the controller may provide the driver protection action signal so that the airbag of the host vehicle operates in advance.

Alternatively, the processor may determine the rear collision against the following vehicle based on the relative velocity and relative distance between the host vehicle and the following vehicle. If the rear collision against the following vehicle is expected, the controller may provide the following vehicle with the signal to warn the emergency braking situation and the emergency braking signal simultaneously.

At this time, the controller may provide a following vehicle warning signal so that a braking lamp or horn of the host vehicle operates.

Furthermore, the processor may determine whether the rear collision against the following vehicle is present based on the relative velocity and relative distance between the host vehicle and the following vehicle. If the rear collision against the following vehicle is not present, the controller may provide an emergency braking signal for the host vehicle.

Alternatively, the controller may provide a signal to control acceleration performance of the host vehicle along with the braking signal for braking the host vehicle.

In this case, the controller may provide a signal to restrict the acceleration performance of the host vehicle so that the acceleration performance is reduced.

### BRIEF DESCRIPTION OF THE DRAWINGS

FIG. 1 is a schematic diagram showing the traveling state of a host vehicle, a preceding vehicle and a following vehicle according to an embodiment of the present invention.

FIG. 2 is a block diagram of an emergency braking apparatus for a vehicle according to an embodiment of the present invention.

FIG. 3 is a flowchart showing an operation of the emergency braking apparatus for a vehicle according to an embodiment of the present invention.

FIG. 4 is a detailed flowchart illustrating an operation of determining whether a driver is inattentive and controlling a host vehicle using the emergency braking apparatus for a vehicle according to an embodiment of the present invention.

FIG. 5 is a detailed flowchart illustrating an operation of determining normal braking and emergency braking using the emergency braking apparatus for a vehicle according to an embodiment of the present invention.

FIG. 6 is a flowchart illustrating an operation of performing normal braking control using the emergency braking apparatus for a vehicle according to an embodiment of the present invention.

FIG. 7 is a flowchart illustrating an operation of performing emergency braking control using the emergency braking apparatus for a vehicle according to an embodiment of the present invention.

<Description of reference numerals>

| | |
|---|---|
| 10: host vehicle | 20: preceding vehicle |
| 30: following vehicle | 100: sensor |
| 110: driver monitoring camera | |
| 120: hands-off sensor | |
| 130: bio sensor | 140: front camera |
| 150: steering sensor | |
| 160: preceding vehicle detection sensor | |
| 200: processor | 300: controller |
| v1: velocity of host vehicle | |
| a1: acceleration of host vehicle | |
| v2: velocity of preceding vehicle | |
| a2: acceleration of preceding vehicle | |
| v3: velocity of following vehicle | |
| a3: acceleration of following vehicle | |
| d1: relative distance between host vehicle | |
| and preceding vehicle | |
| d2: relative distance between host vehicle | |
| and following vehicle | |
| Tc: expected collision time | |
| Dt: target deceleration quantity | |
| Dm: deceleration threshold value | |
| Pt: target pedal force value | |
| Ps: pedal force value | |
| Pm: minimum pedal force value | |

### DETAILED DESCRIPTION

Hereinafter, embodiments of the present invention are described in detail with reference to the accompanying drawings so that a person having ordinary skill in the art to which the present invention pertains may easily practice the embodiments. However, the present invention may be implemented in various different forms and is not limited to the embodiments described herein. Furthermore, in the drawings, in order to clarify a description of the present invention, parts not related to the description are omitted, and the same reference numbers are used to refer to the same or similar parts throughout the specification.

In this specification, it is to be understood that a term, such as “include” or “have”, is intended to designate that a characteristic, number, step, operation, element, part or a combination of them described in the specification is present, and does not exclude the presence or addition possibility of one or more other characteristics, numbers, steps, operations, elements, parts, or combinations of them in advance. Furthermore, when it is described that one part, such as a layer, film, area, or plate, is “over” or “on” the other part, the one part may be “directly” on the other part or a third part may be present between the two parts. In contrast, when it is described that one part is “directly on” the other part, it means that a third part is not present between the two parts.

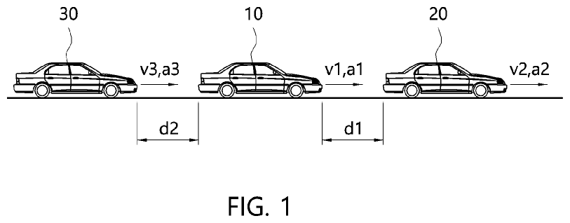

FIG. 1 is a schematic diagram showing the traveling state of a host vehicle 10, a preceding vehicle 20 and a following vehicle 30 according to an embodiment of the present invention. As shown in FIG. 1, the host vehicle 10 travels at a velocity of v1 m/s and an acceleration of a1 m/s². The preceding vehicle 20 travels at a velocity of v2 m/s and an acceleration of a2 m/s². The following vehicle 30 travels at a velocity of v3 m/s and an acceleration of a3 m/s².

In this case, the distance between the host vehicle 10 and the preceding vehicle 20 is d1 m, and the distance between the host vehicle 10 and the following vehicle 30 is d2 m.

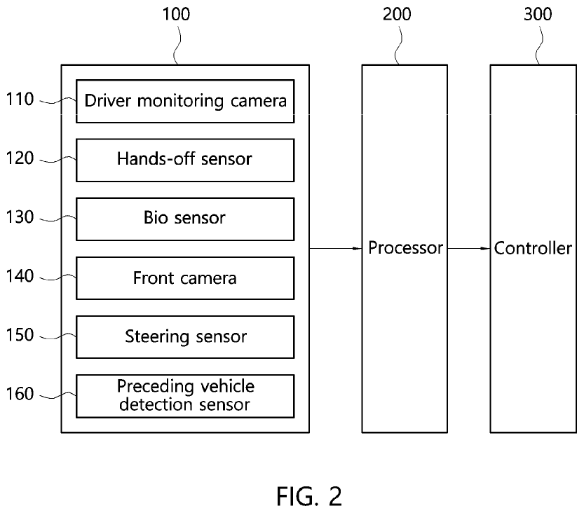

FIG. 2 is a block diagram of an emergency braking apparatus for a vehicle according to an embodiment of the present invention. As shown in FIG. 2, the emergency braking apparatus for a vehicle according to an embodiment of the present invention includes a sensor 100 mounted to the host vehicle 10 and configured to detect the outer and inner areas of the host vehicle 10, a processor 200 configured to process such data collected by the sensor 100, and a controller 300 configured to provide a control signal for controlling the host vehicle 10 based on the data processed by the processor 200. In this case, the sensor 100 detects a state of a driver or a traveling state of the host vehicle 10. The processor 200 determines a level of inattentiveness of the driver based on the detected state of the driver or the detected traveling state of the host vehicle 10. The controller 300 provides a braking signal for braking the host vehicle 10 based on the level of inattentiveness of the driver.

The sensor 100 detects a driving condition of the driver, such as drowsiness, and a traveling state of the host vehicle 10, such as lane departure. The processor 200 determines a level of inattentiveness of the driver based on the detected driving state of the driver or the detected traveling state of the host vehicle 10.

At this time, if the inattention of the driver is detected, it is important to accurately determine whether the driver is inattentive without the intervention of a plurality of steps. If the processor 200 determines a level of inattentiveness of the driver, the controller 300 controls the braking of the host vehicle.

Furthermore, as shown in FIG. 2, a driver monitoring camera 110 for detecting a driving condition of a driver, a hands-off sensor 120 for detecting whether a driver holds a steering handle, a bio sensor 130 for detecting a health state of a driver, a front camera 140 for detecting a traveling state of a vehicle, or a steering sensor 150, which is mounted on a vehicle, may be used as the sensor 100.

To detect a driving state of a driver includes detecting a driving state of a driver through a motion of a driver, for example, a direct motion of the driver, such as an eye-closing or yawning figure related to drowsiness or using an indoor article, such as a smartphone. However, it is important to precisely determine whether a driving state of a driver is a temporary motion intended by the driver or a motion not related to a driver's intention, such as drowsiness.

At this time, a face image of the driver is captured using the driver monitoring camera 110. The inattentive state of the driver is determined based on the captured image. In order to accurately capture a face image of the driver at night in addition to the daytime, a face image of the driver may be captured by radiating an LED. When a face image of the driver is captured by illuminating the LED as described above, a clear face image can be obtained. However, if the driver wears glasses, it may be difficult to determine a driver's condition because the LED is reflected on the lens of the glasses depending on a posture of the driver. In order to reduce such LED reflection, polarization filters having opposite directions may be disposed on the light-emitting unit and light-receiving unit of the LED in order to reduce the reflection of the LED on the lens of the glasses, thereby being capable of reducing.

Alternatively, the hands-off sensor 120 may detect whether a driver's hand has been released from the steering handle of a vehicle or the bio sensor 130 may detect a driving state of a driver by detecting health information, such as the driver's blood pressure.

Furthermore, the front camera 121 or the steering sensor 150 may be used to detect a traveling state of a vehicle. The front camera 121 may detect a traveling state of a vehicle by detecting whether the vehicle keeps its lane during a traveling pattern. The steering sensor 150 is for controlling the traveling direction of a vehicle, and may detect a traveling state of a vehicle.

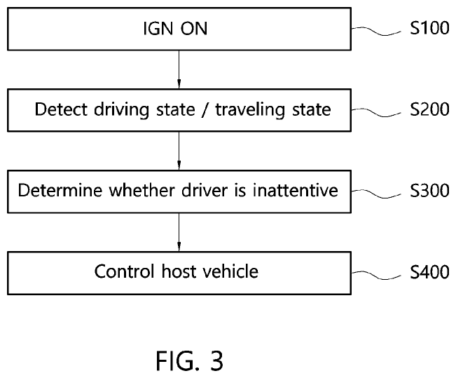

FIG. 3 is a flowchart showing an operation of the emergency braking apparatus for a vehicle according to an embodiment of the present invention. As shown in FIG. 3, if the host vehicle 10 is powered on (S100), the sensor 100 accurately detects a traveling state of the vehicle or a driving state of a driver (S200). The processor 200 precisely determines whether the driver is inattentive based on the detected driving condition or the traveling state of the host vehicle 10 (S300). At this time, the processor 200 determines the level of inattentiveness of the driver based on data collected by the sensor. The controller 300 performs braking control on the host vehicle 10 based on whether the driver is inattentive (S400). Accordingly, an accident occurring while driving can be prevented effectively.

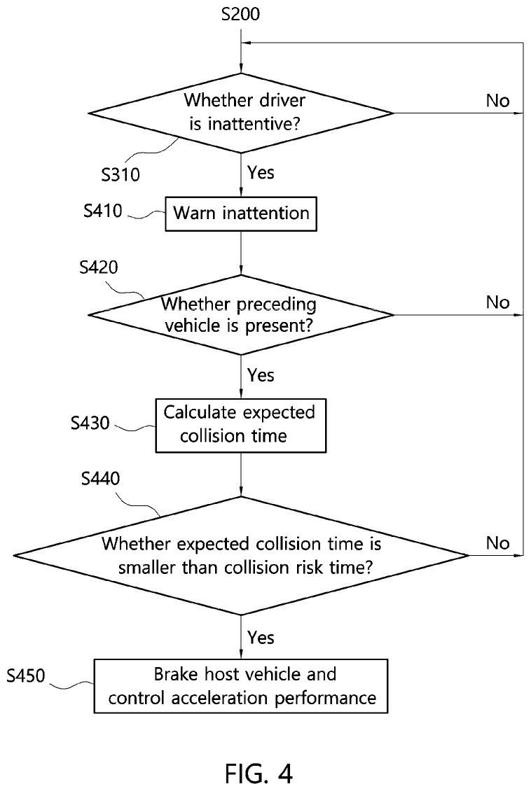

FIG. 4 is a detailed flowchart illustrating an operation of determining whether a driver is inattentive and controlling a host vehicle using the emergency braking apparatus for a vehicle according to an embodiment of the present invention. That is, when the driver is inattentive is determined (S310). If it is determined that the driver inattentive, the driver is warned about the inattention (S410).

The sensor 100 detects whether the preceding vehicle 20 is present. The processor 200 determines whether the preceding vehicle 20 is present based on a result of the detection (S420). As shown in FIG. 4, if it is determined that the preceding vehicle 20 is present, the processor 200 determines an expected collision time (Tc) based on a relative velocity and relative distance between the host vehicle 10 and the preceding vehicle 20 (S430), determines whether to perform braking control on the host vehicle 10 by comparing the expected collision time (Tc) with a collision risk time (S440). If a collision is expected because the expected collision time (Tc) is smaller than the collision risk time, the controller 300 may provide a braking signal for braking the host vehicle 10 (S450).

The sensor 100 may further include a preceding vehicle detection sensor 160 in order to detect whether the preceding vehicle 20 is present.

If the preceding vehicle detection sensor 160 detects the preceding vehicle 20, the processor 200 determines the expected collision time (Tc) based on the relative velocity and relative distance between the host vehicle 10 and the preceding vehicle 20.

That is, as shown in FIG. 1, the processor 200 may determine a relative velocity (v1-v2) based on the velocity (v1) of the host vehicle 10 and the velocity (v2) of the preceding vehicle 20, and may determine the expected collision time (Tc) by dividing the distance (dl) between the host vehicle 10 and the preceding vehicle 20 by the relative velocity (v1-v2).

Furthermore, the processor 200 may determine the expected collision time (Tc) based on the acceleration (a1) of the host vehicle 10 and the acceleration (a2) of the preceding vehicle 20.

The processor 200 determines whether the determined expected collision time (Tc) is smaller than the collision risk time (S440). If the expected collision time (Tc) is smaller than the collision risk time, the controller 300 provides a braking signal for braking the host vehicle 10 (S450).

In this case, the collision risk time means timing where the braking signal for braking the host vehicle 10 is provided in preparation for a collision against the preceding vehicle 20. That is, if the collision risk time is set as “a” second, when the expected collision time (Tc) is smaller than “a” second, the controller 300 provides the braking signal for braking the host vehicle 10.

The collision risk time may be determined as a given value when the emergency braking apparatus for a vehicle is fabricated, but a user may select a plurality of collision risk times.

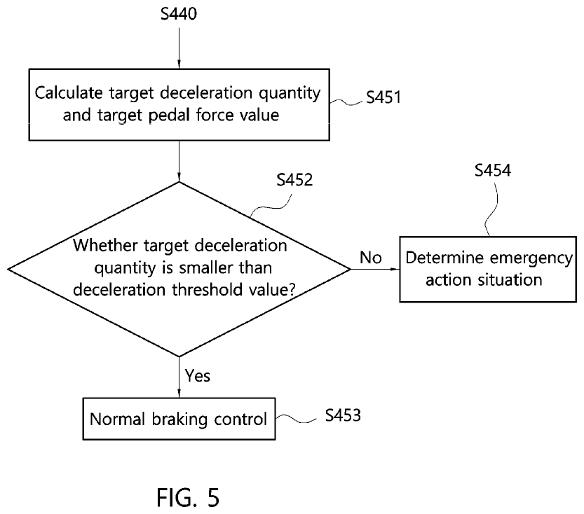

FIG. 5 is a detailed flowchart illustrating an operation of determining normal braking and emergency braking using the emergency braking apparatus for a host vehicle according to an embodiment of the present invention.

As shown in FIG. 5, in order for the relative velocity (v1-v2) between the host vehicle 10 and the preceding vehicle 20 to become a given velocity or less, the processor 200 determines a target deceleration quantity (Dt) of the host vehicle 10 and a target pedal force value (Pt) necessary to reach the target deceleration quantity (Dt) (S451), and determines whether the target deceleration quantity (Dt) is smaller than a deceleration threshold value (Dm) which may be reduced through emergency braking (S452).

If the target deceleration quantity (Dt) is smaller than the deceleration threshold value (Dm), the processor 200 may determine that normal braking is possible (S453).

That is, if the target deceleration quantity (Dt) can be reached using a pedal force through a brake pedal, the processor 200 determines that normal braking is possible not emergency braking.

As described above, in the situation in which normal braking is possible, the controller 300 may provide the braking signal for braking the host vehicle 10 based on the pedal force value (Ps) of the brake pedal of the host vehicle 10.

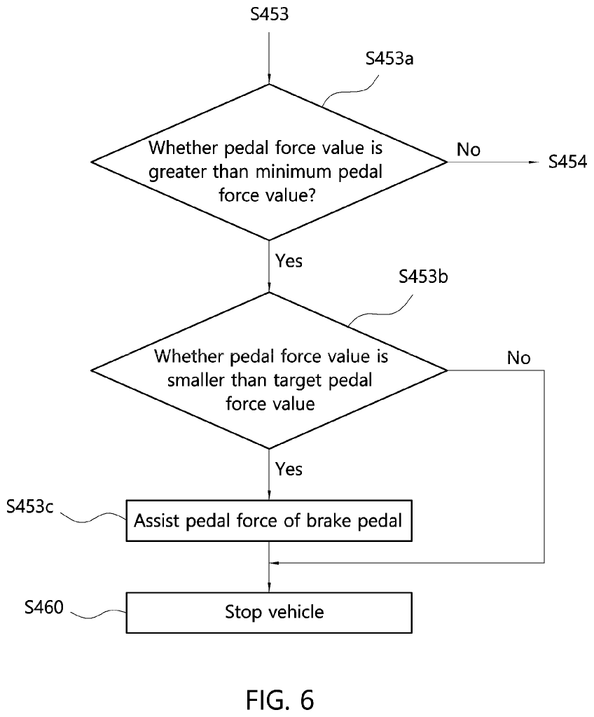

FIG. 6 is a flowchart illustrating an operation of performing normal braking control using the emergency braking apparatus for a host vehicle according to an embodiment of the present invention.

As shown in FIG. 6, the processor 200 compares the pedal force value (Ps) with a minimum pedal force value (Pm) (S453a). In this case, the minimum pedal force value (Pm) means a minimum pedal force of the brake pedal for determining a driver's deceleration intention.

If the pedal force value (Ps) is greater than the minimum pedal force value (Pm) for the braking of the host vehicle 10, the processor 200 determines that the driver has a braking intention, and compares the pedal force value (Ps) with the target pedal force value (Pt) (S453b). The controller 300 may provide a braking signal for braking the host vehicle 10.

If the pedal force value (Ps) is not greater than the minimum pedal force value (Pm) for the braking of the host vehicle 10, the processor 200 may determine to change a current situation into a situation in which an emergency action is necessary (S454).

As described above, the pedal force value (Ps) is compared with the target pedal force value (Pt) (S453b). If the pedal force value (Ps) is smaller than the target pedal force value (Pt), the controller 300 may assist the pedal force of the brake pedal so that the pedal force value (Ps) reaches the target pedal force value (Pt) (S453c). Accordingly, the vehicle can be stably stopped (S460).

Alternatively, if the pedal force value (Ps) is not smaller than the target pedal force value (Pt), the controller 300 may stop the vehicle by providing a braking signal for braking the host vehicle 10 based on the pedal force value (Ps) (S460).

As described above, the processor 200 determines the target deceleration quantity (Dt) at which the host vehicle 10 needs to be decelerated so that the relative velocity between the host vehicle 10 and the preceding vehicle 20 becomes a given velocity or less. As shown in FIG. 5, if the target deceleration quantity (Dt) is greater than the deceleration threshold value (Dm) which may be decelerated through emergency braking, the processor 200 determines that an emergency action is necessary (S454).

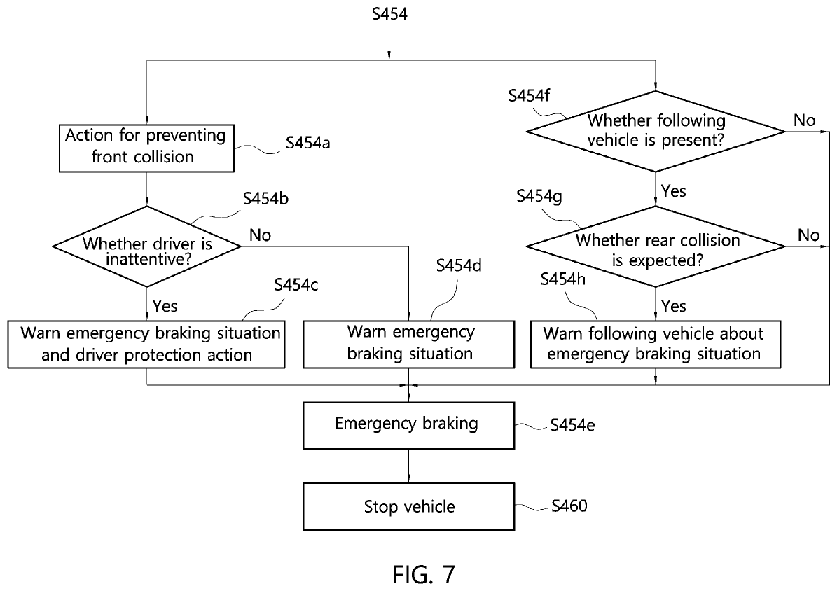

FIG. 7 is a flowchart illustrating an operation of performing emergency braking control using the emergency braking apparatus for a host vehicle according to an embodiment of the present invention. As shown in FIG. 7, in the situation in which an emergency action is necessary, the controller 300 may provide an emergency action signal for preventing a front collision against the preceding vehicle 20 (S454a) and simultaneously provide an emergency action signal for preventing a rear collision against the following vehicle 30.

At this time, the processor 200 determines whether the driver is inattentive based on data collected by the sensor 100 (S454b). That is, whether the driver is inattentive continues to be detected in the front collision prevention action process.

If the driver is not inattentive and an emergency action is necessary, the controller 300 may provide a signal to warn an emergency braking situation, a driver protection action signal (S454c), and an emergency braking signal (S454e) at the same time.

In this case, the controller 300 may provide the driver protection action signal so that the airbag of the host vehicle 10 operates in advance.

Alternatively, the processor 200 determines a level of inattentiveness of the driver based on data collected by the sensor 100 (S454b). If an emergency action is necessary based on the level of inattentiveness of the driver, the controller 300 may provide a signal to warn an emergency braking situation (S454d) and an emergency braking signal (S454e) at the same time.

Alternatively, the processor 200 may determine whether the following vehicle 30 is present based on data collected by the sensor 100 (S454f), and may determine whether there is a rear collision against the following vehicle 30 based on a relative velocity (v1-v3 or v3-v1) and relative distance (d2) between the host vehicle 10 and the following vehicle 30 (S454g). If a rear collision against the following vehicle 30 is expected, the controller 300 may provide the following vehicle 30 with a signal to warn an emergency braking situation (S454h) and an emergency braking signal (S454e) at the same time.

At this time, the controller 300 may provide a following vehicle warning signal so the braking lamp or horn of the host vehicle 10 operates (S454h).

Furthermore, the processor 200 may determine whether there is a rear collision against the following vehicle based on the relative velocity (v1-v3 or v3-v1) and relative distance (d2) between the host vehicle 10 and the following vehicle 30 (S454g). If a rear collision against the following vehicle 30 is not present, the controller 300 may provide an emergency braking signal to the host vehicle 10.

Alternatively, the controller 300 may provide a signal to control acceleration performance of the host vehicle along with a braking signal for braking the host vehicle 10 (S450).

In this case, the controller 300 may provide a signal to restrict acceleration performance so that acceleration performance of the host vehicle 10 is reduced.

If an unexpected situation in which a collision against the preceding vehicle 20 is expected occurs while a driver is an inattentive state, it may be difficult for the driver to think normally. Accordingly, the driver may step on an acceleration pedal by mistake without stepping on a brake pedal for the deceleration of the host vehicle 10, thereby resulting in a more serious accident. As described above, if a collision is expected, the controller 300 controls acceleration performance so that the acceleration of a vehicle is slowed down although a driver mistakenly steps on an acceleration pedal. Accordingly, an accident can be prevented although a driver is inattentive.

Furthermore, although a driver involves braking or performs an erroneous manipulation, efficient driving support and vehicle control can be performed by assisting a brake pedal force or through control of emergency braking or acceleration performance of a vehicle.

The emergency braking apparatus for a host vehicle according to an embodiment of the present invention can effectively prevent the occurrence of an accident during driving by accurately determining whether a driver is inattentive using various detection members and controlling a vehicle braking apparatus by incorporating the inattentive condition of the driver.

Furthermore, the emergency braking apparatus can effectively protect a driver by controlling the vehicle braking apparatus with consideration taken of whether a preceding vehicle is present, a collision warning distance, and a distance from the preceding vehicle.

Furthermore, the emergency braking apparatus can effectively prevent a chain collision attributable to a rear collision against a following vehicle by determining whether the rear collision is present upon emergency braking and warning the following vehicle about the emergency braking.

Furthermore, the emergency braking apparatus can provide efficient driving support and vehicle control by performing brake pedal force assistance or emergency braking or through control of acceleration performance although a driver involves braking or performs an erroneous manipulation.

The embodiments of the present invention have been described above, but the spirit of the present invention is not limited to the embodiments proposed in this specification and a person who understands the spirit of the present invention may readily propose other embodiments based on the addition, change, deletion or supplement of an element within the range of the same spirit. Such embodiments may be said to fall within the spirit of the present invention.

What is claimed is:

1. An emergency braking apparatus for a host vehicle, comprising:
a sensor mounted to the host vehicle and configured to detect an outer or inner area of the host vehicle;
a processor configured to process data collected by the sensor; and
a controller configured to provide control signals for controlling the host vehicle based on the data processed by the processor,
wherein the sensor detects a state of a driver or a traveling state of the host vehicle,
the processor determines a level of inattentiveness of the driver based on the detected state of the driver or the detected traveling state of the host vehicle, and
the controller provides a braking signal for braking the host vehicle based on the level of inattentiveness of the driver.

2. The apparatus of claim 1, wherein the sensor detects a motion of the driver or the traveling state of the host vehicle.

3. The apparatus of claim 1, wherein:
the sensor detects whether a preceding vehicle is present, and
the processor determines an expected collision time based on a relative velocity and relative distance between the host vehicle and the preceding vehicle if the preceding vehicle is present and determines whether a collision occurs by comparing the expected collision time with a collision risk time, and
the controller provides the braking signal for braking the host vehicle if the expected collision time is smaller than the collision risk time.

4. The apparatus of claim 3, wherein:
the processor determines a target deceleration quantity to be reached by the host vehicle and a target pedal force value necessary to reach the target deceleration quantity in order for the relative velocity between the host vehicle and the preceding vehicle is a given velocity or less, and
if the target deceleration quantity is smaller than a deceleration threshold value reachable through emergency braking, the processor determines a situation in which normal braking is possible.

5. The apparatus of claim 4, wherein in the situation in which normal braking is possible, the controller provides the braking signal for braking the host vehicle based on a pedal force value of a brake pedal of the host vehicle.

6. The apparatus of claim 5, wherein if the pedal force value is smaller than a minimum pedal force value capable of braking the host vehicle, the processor determines to change into a situation in which an emergency action is necessary.

7. The apparatus of claim 5, wherein if the pedal force value is not smaller than the minimum pedal force value capable of braking the host vehicle,
the processor compares the pedal force value with the target pedal force value, and
the controller provides the braking signal for braking the host vehicle.

8. The apparatus of claim 7, wherein if the pedal force value is smaller than the target pedal force value, the controller assists the pedal force of the brake pedal so that the pedal force value reaches the target pedal force value.

9. The apparatus of claim 8, wherein if the pedal force value is not smaller the target pedal force value, the controller provides the braking signal for braking the host vehicle based on the pedal force value.

10. The apparatus of claim 3, wherein:
the processor determines a target deceleration quantity for the host vehicle so that the relative velocity between the host vehicle and the preceding vehicle is a given velocity or less, and
if the target deceleration quantity is greater than a deceleration threshold value reachable through emergency braking, the processor determines a situation in which an emergency action is necessary.

11. The apparatus of claim 10, wherein in the situation in which an emergency action is necessary, the controller provides an emergency action signal for preventing a front collision against the preceding vehicle and a rear collision against a following vehicle.

12. The apparatus of claim 11, wherein:
the processor determines a level of inattentiveness of the driver based on data collected by the sensor, and
if an emergency action is necessary based on the level of inattentiveness of the driver, the controller provides a signal to warn an emergency braking situation, a driver protection action signal, and an emergency braking signal simultaneously.

13. The apparatus of claim 12, wherein the controller provides the driver protection action signal so that an airbag of the host vehicle operates in advance.

14. The apparatus of claim 11, wherein:
the processor determines the rear collision against the following vehicle based on the relative velocity and relative distance between the host vehicle and the following vehicle, and
if the rear collision against the following vehicle is expected, the controller provides the following vehicle with the signal to warn the emergency braking situation and the emergency braking signal simultaneously.

15. The apparatus of claim 14, wherein the controller provides a following to vehicle warning signal so that a braking lamp or horn of the host vehicle operates.

16. The apparatus of claim 11, wherein:
the processor determines whether the rear collision against the following vehicle is present based on the relative velocity and relative distance between the host vehicle and the following vehicle, and
if the rear collision against the following vehicle is not present, the controller provides an emergency braking signal for the host vehicle.

17. The apparatus of claim 3, wherein the controller provides a signal to control acceleration performance of the host vehicle along with the braking signal for braking the host vehicle.

18. The apparatus of claim 16, wherein the controller provides a signal to restrict the acceleration performance of the host vehicle so that the acceleration performance is reduced.

19. The apparatus of claim 6, wherein in the situation in which an emergency action is necessary, the controller provides an emergency action signal for preventing a front collision against the preceding vehicle and a rear collision against a following vehicle.
